(19) United States
(12) Patent Application Publication
(10) Pub. No.: US 2010/0224491 A1
(43) Pub. Date: Sep. 9, 2010

(54) Solid-State Electrolyte Gas-Sensor Element

(76) Inventors: Eric Tabery, Jockgrim (DE); Oliver Dotterweich, Oberhaid (DE); Andreas Opp, Rutesheim (DE); Antje Taeuber, Hirschaid (DE); Frank Buse, Karlsruhe (DE); Christoph Renger, Bamberg (DE); Harald Guenschel, Gerach (DE)

Correspondence Address: KENYON & KENYON LLP, ONE BROADWAY, NEW YORK, NY, 10004, US

(21) Appl. No.: 12/086,855

(22) PCT Filed: Nov. 21, 2006
(86) PCT No.: PCT/EP2006/068703

§ 371 Date: Apr. 29, 2010

(30) Foreign Application Priority Data
Dec. 20, 2005 (DE) 102005060864.7

(51) Int. Cl. G01N 27/26

(52) U.S. Cl. 204/432; 204/431

(57) ABSTRACT

A gas-sensor element having a layer-type arrangement or configuration, in particular for determining gas components and/or concentrations of gas components of a measuring gas, having a sensor cell, including a first electrode, which is to be exposed to the measuring gas, a second electrode, which is to be exposed to a reference gas, and a solid-state electrolyte situated between the two electrodes, including a reference-air channel situated between the electrode that is exposed to the reference gas and the solid-state electrolyte, and including a heating element. In the superposition of two gas-sensor element layers, a path formed by an electrode facing the heating element is developed at a lateral offset with respect to a path formed by the heating element.

### FIELD OF THE INVENTION

The present invention relates to a gas-sensor element.

### BACKGROUND INFORMATION

Gas-sensor elements typically have a layered configuration. In addition to sturdier layers, which are referred to as carrier foils, such sensor elements include additional functional layers, e.g., electrodes, heat- and gas-supply elements, which are usually applied on one or a plurality of such carrier foils. They ensure the supply of the operating means required for proper operation of the electro-chemical gas-sensor element, such as reference gas, often in the form of air, and also heat so as to bring a sensor cell element, made up of at least two electrodes and a solid-state electrolyte disposed between them, to operating temperature.

As a rule, such sensor elements are constructed of at least three carrier foils, which are provided with corresponding supplementary layers, zirconium oxide often being used to produce the carrier foils. A first external carrier layer, or carrier foil, forms the solid-state electrolyte of the sensor cell required for an ion-conducting connection between two electrodes. The spatial extension of the sensor element defined by the second, center carrier foil was generally used to accommodate the reference-gas supply in the form of one or a plurality of reference-gas channels, depending on the design. In these specific developments, the heating element, which supplies the sensor cell with heat, is situated in the sensor element on the side of the center carrier coil facing away from the sensor cell, which may be in the form of thin screen print layer on the inside of the third, likewise outer carrier layer.

A measuring voltage, which is generated by the electro-chemical sensor cell thus heated by the ion flow through the solid-state electrolyte and applied at the two electrodes, is a measure for the partial pressure of the oxygen between the measuring gas and the reference gas. However, since this voltage is additionally very much dependent upon the temperature of the measuring cell, even upon the temperature of the individual elements of the measuring cell, the first and second electrode or solid-state electrolyte, both temperature gradients and temperature fluctuations also heavily influence the corresponding measuring result through the introduction of errors. In certain sensor developments, for example, temperature fluctuations in the range of ±40° C. about the specified operating temperature were determined, e.g., with an operating temperature ranging from approximately 700° C. to 900° C. Such temperature fluctuations therefore interfere with the measuring result of the electro-chemical measuring cell.

To reduce such system-inherent measuring errors, DE 196 09 323 A1 discusses a design for a sensor element in which the internal resistance of the sensor cell is reduced by positioning the heating element, which typically has a meander shape, directly underneath the region of the center carrier foil connecting the two outer carrier foils. This makes it possible to achieve a rapid heat transfer through the center carrier foil to the sensor cell, and thereby to reduce the power loss that drops at this internal resistor and has a negative influence on the measuring result. Additional publications focusing on this topic include DE 43 43 089 A1, DE 101 15 872 A1, and DE 103 05 533 A1.

### SUMMARY OF THE INVENTION

Therefore, the exemplary embodiments and/or the exemplary methods of the present invention is based on an objective of improving a sensor element designed according to the related art as described at the outset.

This object is achieved by the features of the exemplary embodiments and/or the exemplary methods of the present invention as described herein.

Accordingly, the exemplary embodiments and/or the exemplary methods of the present invention relates to a gas-sensor element, in particular for determining at least one gas component and/or at least one concentration of gas components of a measuring gas, the gas-sensor element having a sensor cell, which includes a first electrode to be exposed to the measuring gas, a second electrode to be exposed to a reference gas, and a solid-state electrolyte situated between the two electrodes, as well as having a heating element, one path of an electrode facing the heating element being spatially superposed at a lateral offset to a path of the heating element. It is characterized in that a reference-air channel is situated between the electrode exposed to the reference gas and the solid-state electrolyte.

The reference channel may advantageously be formed as gas-permeable insulating layer between the electrode to be exposed to the reference gas and the solid-state electrolyte, for instance in the form of an open-pored printed layer.

To ensure the functionality of the measuring cell, an ion-conducting connection between the solid-state electrolyte and the electrode to be exposed to the reference gas may advantageously be formed, which may be laterally around the insulating layer. This creates a detour for the ion flow, which increases the internal resistance of the measuring cell and stabilizes the measuring signal.

In such electro-chemical gas-sensor elements, the sensor cell's reference gas supply is applied with an enormous clearance-reducing effect between the two outer carrier foils simply as thin print layer on the underside of the first external carrier layer used as carrier element for the sensor cell, and is no longer implemented in the spatial extension of a center carrier foil. Because the currently typical center carrier foil is dispensed with and because of the related massive reduction in clearance between the sensor cell and the heating element heating it, even faster heating of the individual sensor cell elements is now taking place. Additional measures are able to be taken in order to prevent a high temperature gradient from arising during the heating phase between the heater-proximal and the heater-distal sensor cell elements across the spatial extension of the sensor cell.

It is advantageous, for instance, if the path formed by the electrode is situated in a superposition without overlap with respect to the path formed by the heating element. A sensor element having such a design makes it possible to reduce the thermal incoupling of the heater into the measuring result in two regards. It is possible, for one, to lower temperature gradients between sensor cell elements distal and proximal to the heater. For another, it also allows a reduction in the temperature-fluctuation range of the measuring cell due to a relatively more uniform and constant temperature distribution in the measuring cell that is able to be achieved thereby.

In the superposition of two gas-sensor element layers, an additional improvement with regard to the most optimal uniform temperature distribution in the sensor-cell element can be obtained if the path formed by the electrode is disposed in a region between two sections of a heating element connected by a sharp turn.

Additional support for a uniform temperature distribution in the sensor-cell region may be achieved by forming a thermal barrier in the direct connection between a path formed by an electrode facing the heating element and a path formed by the heating element, once again in the context of the superposition of the individual gas-sensor element layers.

Especially suitable for the formation of such a thermal barrier is a cavity between these paths. It has a largely heat-insulating effect, so that the predominant part of the heat transfer between the sensor cell and the heating element and/or an additional sensor element supporting the heating element is implemented via a detour through the remaining structural elements of the two carrier layers and possibly additional interposed layers such as laminate layers or the like. Some of these layers may also replace the cavity. Thus, these elements likewise assume the function of a heat-conducting element to facilitate a more homogenous temperature distribution in the sensor-cell element. Furthermore, this characteristic specifically also applies to the elements that support the electrode proximal to the heating element or that are in heat-conducting connection with such elements.

Moreover, for additional aid in a more uniform temperature distribution, especially also for achieving better measuring results due to a relatively higher internal resistance of the sensor cell, a fork-like design of one path of at least one electrode is provided in addition. Once again, this may be an electrode proximal to the heater and usually involves the reference-gas electrode.

For one, such a fork-like design of the path enables an excellent adaptation to the contours of a heating element having a meander-like form. For another, in the case of a reference-air channel with a likewise fork-like design, which after all is situated between the reference electrode and the solid-state electrolyte, a further increase in the internal resistance of the sensor cell may be achieved by a forced detour of the ion transport between the measuring electrode and the reference electrode.

This forced detour for the ion flow is achievable as a result of an insulating characteristic of the reference-air channel in conjunction with an additional creation of an ion-conducting connection in the edge region of the reference-air channel between the solid-state electrolyte and the particular electrode, as well as by an ion-conducting layer underneath the electrode.

Moreover, the design of such fork-like electrodes is also based on the finding that because of the insulating function of the reference-gas channel as a function of the thickness of the ion-conducting layer underneath the electrode, it is basically the edge regions of the electrodes that are utilized for the ion flow for the most part. According to this finding, the fork-like design of the electrodes, for one, reduces an unnecessary use of platinum for the not required electrode areas. For another, it also causes the edge region of the electrode to become larger so that a shortening of the sensor-cell region is able to be achieved in addition.

However, in addition to the fork-like contours of the electrode, other contours have such advantageous characteristics as well, e.g., ring-shaped electrodes having round or oval contours. They, too, virtually double the edge contours via the sum of the outer and inner edge region.

The exemplary embodiments and/or the exemplary methods of the present invention is explained in greater detail on the basis of the drawing and the following description referring thereto.

### BRIEF DESCRIPTION OF THE FIGURES

FIG. 1 shows an enlarged representation of a sectional view through a sensor element according to the sectional line I-I from FIG. 2.

FIG. 2 shows a plan view of a sensor element with schematically sketched electrode and heater, according to line II-II in FIG. 1.

FIG. 3 shows an additional sectional view through a sensor element in a modification of FIG. 1.

### DETAILED DESCRIPTION

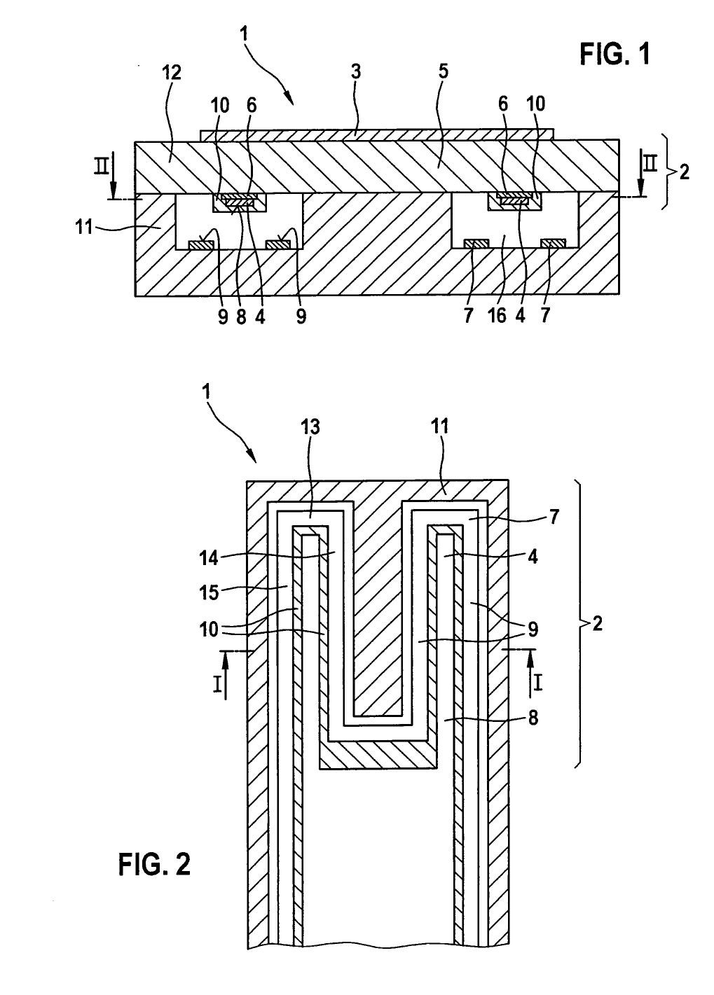

FIG. 1 shows a schematic sectional view through a layered gas-sensor element 1 made up of two carrier layers 11, 12. The two carrier layers 11, 12 essentially form the basic structure of sensor element 1. They are provided with additional elements 3 through 10 in the form of layers to form an electro-chemical sensor cell 2 intended for a specific operating-temperature range.

To determine gas components and/or concentrations of gas components of a measuring gas, sensor cell 2 includes a first electrode 3, which is to be exposed to the measuring gas, a second electrode 4, which is to be exposed to a reference gas, and an ion-conducting solid-state electrolyte 5 situated between them. A reference-gas channel 6 situated between solid-state electrolyte 5 and reference electrode 4 is provided for the supply of reference gas to reference electrode 4.

To bring sensor cell 2 to operating temperature, a heating element 7 is formed on lower carrier layer 11. Since the measuring voltage supplied by measuring cell 2 and to be picked off at the two electrodes 3, 4 is highly temperature-dependent, both temperature gradients that occur across the spatial extension of the sensor cell as well as temperature fluctuations of the measuring cell itself have an error-producing effect on the measuring result.

In order to reduce this error source, it is therefore provided to implement and situate the heater-proximal electrode—in this case, reference electrode 4—in such a way that it is laterally offset in relation to heating element 7 in the layer structure of the gas-sensor element. Due to an overlap-free offset between path 8 formed by electrode 4 and path 9 formed by heater 7, possibly even with a space between the edges of the two elements, the direct heat input of heating element 7 into reference electrode 4 is able to be reduced considerably.

One advantageous geometric form for heater-proximal reference electrode 4 can be gathered from FIG. 2, in which path 8 formed by electrode 4 in the superposition of the layers of the gas-sensor element is disposed in the region between two sections 14, 15 of heating element 5, which are connected by a sharp bend 13. To enhance the heating effect, heating element 5 may have a meander shape, for example, so that path 8 of electrode 4 is advantageously able to be situated in the shape of a fork between two such meandering heater loops in the layer-type superposition of the gas-sensor element.

A further improvement with regard to a temperature stabilization of sensor cell 2 is achieved if a thermal barrier 16 is formed between heater-proximal electrode 4 and heater 7. The formation of a cavity 16, which is simply filled with air, is especially advantageous in this instance. Cavity 16 itself is able to be formed with the aid of agents that dissolve during curing of the sensor element. Advantageous placement and/or dimensioning of individual elements of the gas-sensor element turns the components lying between sensor cell 2 and heating element 5 and/or further sensor element 11 supporting heating element 5 into heat-conducting elements, which facilitate a uniform heat distribution within sensor cell 2. This is specifically due to the heat flow that travels through them from heater 7 to sensor cell 2. The path of the heat flow may be implemented both via the contour of the particular sensor components and also by controlling their thermal conductivity in specific spatial extensions. This makes it possible to achieve relatively uniform heating both across the longitudinal extension of sensor cell 2, corresponding to the illustration in FIG. 2, and also across its transversal extension, corresponding to the illustration in FIG. 1.

This routing of the heat has a positive effect with regard to the temperature fluctuations between individual heating cycles of heating element 7, inasmuch as a relatively long heating path is created and therefore a path that dampens temperature peaks.

Analogously to the fork-type design of reference electrode 4, reference-air channel 6 also has a fork-type design. However, in order to force a detour of the ion flow between measuring electrode 3 and reference electrode 4, its path is larger than the path of the reference electrode and completely insulates it in the direct connection with solid-state electrolyte 5. The ion routing from solid-state electrolyte 5 to reference electrode 4 is therefore possible only via an ion-conducting connection 10, which laterally bypasses this insulation. Such a design also increases the internal resistance of the measuring cell by stabilizing the measuring result, due to the detour of the ions towards the side edge of reference electrode 4 it induces.

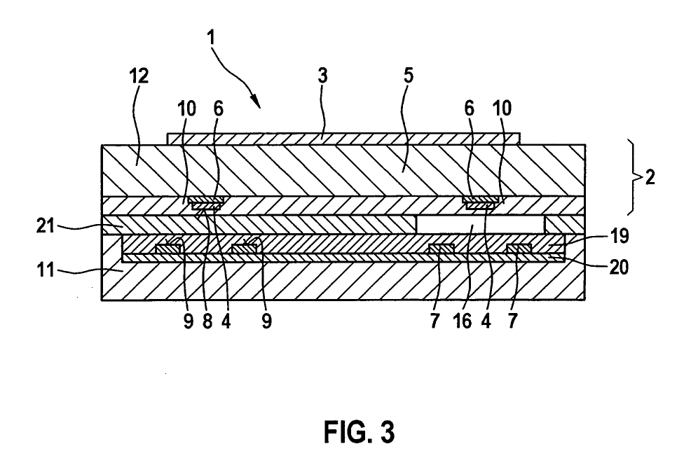

In a variation of FIG. 1, FIG. 3 shows additional elements of possible embodiments of a sensor element. The two additional sketched layers 19, 20 symbolize an electric insulation of heater 7 from the sensor cell. Connection 10, which in FIG. 1 is developed as cover of electrode 4 and of reference-air channel 6, in a variation thereto is designed as full-area foil-binder layer 10 in this instance.

Analogously to the illustration in FIG. 1, thermal barrier 16 in the form of a cavity is shown on the right side of the figure. On the left, a thermal barrier 21 in the form of a foil binder layer 21 is shown as an additional potential embodiment, which may likewise be applied as surface print on the top surface of lower substrate 11, in this instance, specifically on insulation layer 19. Of course, this layer may also be formed across the entire width of the sensor element. The specific embodiments shown here illustrate different potential developments merely by way of example.

Accordingly, given appropriate thickness of one or a plurality of foil binder layers 10, a sufficiently uniform heat distribution is possible as well, which, although perhaps lower than in the case of introduced cavity 16, in comparison still advantageously introduces greater mechanical strength, especially greater thermo-shock stability, into the sensor element.

Tests have shown that it is not only the edge regions of the reference electrode that enter into the internal resistance of the sensor element due to their ion routing into the internal resistance. The layer thickness of the ion-conducting layer—in this instance, connection layer 10—plays a decisive role as well. The thicker it is, the lower the internal resistance and the greater the contribution of the entire surface of the reference electrode. The layer thickness of this layer 10 may be between 20 μm and 80 μm in the sintered state, and between 40 μm and 100 μm in the green state.

1-10. (canceled)

11. A gas-sensor element for determining at least one of a gas component and at least one concentration of gas components of a measuring gas, comprising:
a sensor cell having a first electrode, which is to be exposed to the measuring gas;
a second electrode, which is to be exposed to a reference gas;
a solid-state electrolyte disposed between the two electrodes; and
a heating element;
wherein one path of an electrode facing the heating element is situated at a lateral offset to another path of the heating element in a spatial superposition, and
wherein a reference-air channel is situated between the electrode that is exposed to the reference gas and the solid-state electrolyte.

12. The gas-sensor element of claim 11, wherein the reference-air channel is formed as a gas-permeable insulating layer between the electrode that is to be exposed to the reference gas and the solid-state electrolyte.

13. The gas-sensor element of claim 11, wherein an ion-conducting connection is formed between the solid-state electrolyte and the electrode that is to be exposed to the reference gas.

14. The gas-sensor element of claim 11, wherein the path of the electrode is disposed in an overlap-free superposition with respect to the path formed by the heating element.

15. The gas-sensor element of claim 11, wherein a thermal barrier is formed in a direct connection between a path formed by the electrode and another path formed by the heating element.

16. The gas-sensor element of claim 11, wherein the thermal barrier is a cavity.

17. The gas-sensor element of claim 11, wherein a heat-conducting element is formed between at least one of the heating element and an additional sensor element supporting the heating element, and the sensor cell.

18. The gas-sensor element of claim 11, wherein a heat-conducting element is formed between at least one of the heating element and an additional sensor element supporting the heating element, and an element supporting the electrode.

19. The gas-sensor element of claim 11, wherein the electrode that is to be exposed to the reference gas has a fork-type design.

20. The gas-sensor element of claim 11, wherein the reference-air channel has a fork-type design.
